(19) United States
(12) Patent Application Publication
(10) Pub. No.: US 2026/0211427 A1
(43) Pub. Date: Jul. 23, 2026

(54) Device and Method for Robotic Predictive Maintenance, Diagnostics, and Component Replacement

(71) Applicant: Microchip Technology Inc., Chandler, AZ (US)

(72) Inventors: Steve Nagel, Chandler, AZ (US); Bomy Chen, Newark, CA (US)

(73) Assignee: Microchip Technology Inc., Chandler, AZ (US)

(21) Appl. No.: 19/416,201

(22) Filed: Dec. 11, 2025

Related U.S. Application Data
(60) Provisional application No. 63/755,562, filed on Feb. 7, 2025.
(60) Provisional application No. 63/747,920, filed on Jan. 22, 2025.

(51) Int. Cl. G05D 1/689; G05B 13/02; G05D 105/80

(52) U.S. Cl. CPC G05D 1/689; G05B 13/0265; G05D 2105/80

(57) ABSTRACT

A method is provided comprising communicating with a semi-autonomous or autonomous robot to coordinate retrieval of a sensor pack from a location proximate the first equipment; retrieving sensor data from the sensor pack; inputting the data from the sensor pack to a machine learning model; decoding a response from the machine learning model to identify a specific intervention; and dispatching the semi-autonomous or autonomous robot to the first equipment to perform an intervention.

### RELATED PATENT APPLICATIONS

This application claims priority to U.S. Provisional Application No. 63/755,562 filed February 7, 2025, the entire contents of which are hereby incorporated by reference. This application also claims priority to U.S. Provisional Application No. 63/747,920 filed January 22, 2025, the entire contents of which are hereby incorporated by reference.

### FIELD OF THE INVENTION

This disclosure relates to automated sensor deployment and retrieval.

### BACKGROUND

Some types of equipment may be susceptible to wear or other degradation over time. Equipment manufacturers may choose to incorporate sensors to identify a need for maintenance or repair. However, sensors add to the capital outlay for purchasing the equipment. Further, some sensors may need to be recalibrated or replaced over time. Equipment may be deployed in remote or hazardous environments.

### SUMMARY

In some examples, a method is provided comprising delivering a sensor pack to a deployment location near a first equipment to be monitored, the sensor pack including a processor, a non-transitory computer readable memory, a battery, a data port, and at least one sensor; deploying the sensor pack using a semi-autonomous or autonomous robot to the first equipment; retrieving the sensor pack from the first equipment using the semi-autonomous or autonomous robot; charging the battery of the sensor pack; downloading sensor data from the sensor pack; and sending downloaded sensor data from the sensor pack to a processor remote from the deployment location. In certain examples, the method comprises affixing the sensor pack to the first equipment and affixing the at least one sensor to the first equipment. In certain examples, the method comprises scanning the first equipment for an identifier; retrieving from a database a predetermined location for placing a sensor on the first equipment; and affixing the at least one sensor to the predetermined location on the first equipment. In certain examples, the method comprises retrieving from the database a second predetermined location for placing a second sensor on the first equipment; and affixing a second sensor of the sensor pack to the second predetermined location on the first equipment. In certain examples, the method comprises, before retrieving the sensor pack from the first equipment, deploying a second sensor pack using the semi-autonomous or autonomous robot to a second equipment. In certain examples, the method comprises after retrieving the sensor pack from the first equipment, deploying the sensor pack using the semi-autonomous or autonomous robot to a second equipment. In certain examples, the human control input to the semi-autonomous or autonomous robot is provided from a location remote from the robot.

In some examples, a system is provided comprising a sensor deployment vehicle including a vehicle power supply, a vehicle processor, a vehicle non-transitory computer readable memory, and at least one sensor pack; and an autonomous or semi-autonomous sensor deployment robot including a robot power supply, a robot processor, a robot non-transitory computer readable memory, and a robot arm for deploying the at least one sensor pack; wherein the at least one sensor pack includes a sensor battery, a sensor processor, a sensor non-transitory computer readable memory, and at least one sensor; the robot non-transitory computer readable memory comprising instructions, that when executed on the processor, deploy the at least one sensor pack using a semi-autonomous or autonomous robot to a first equipment; retrieve the at least one sensor pack from the first equipment using the semi-autonomous or autonomous robot; and connect the at least one sensor pack to the sensor deployment vehicle to charge the battery of the sensor pack and download sensor data from the sensor pack. In certain examples, the robot non-transitory computer readable memory comprising instructions that when executed on the processor, affix the at least one sensor pack to the first equipment and affix the at least one sensor to the first equipment. In certain examples, the robot non-transitory computer readable memory comprising instructions that when executed on the processor: scan the first equipment for an identifier; retrieve from a database a predetermined location for placing a sensor on the first equipment; and affix the at least one sensor to the predetermined location on the first equipment. In certain examples, the robot non-transitory computer readable memory comprising instructions that when executed on the processor: retrieve from the database a second predetermined location for placing a second sensor on the first equipment; and affix a second sensor of the sensor pack to the second predetermined location on the first equipment. In certain examples, the robot non-transitory computer readable memory comprising instructions that when executed on the processor, before retrieving the sensor pack from the first equipment, deploy a second sensor pack to a second equipment. In certain examples, the robot non-transitory computer readable memory comprising instructions that when executed on the processor: after retrieving the sensor pack from the first equipment, deploy the sensor pack to a second equipment. In certain examples, the human control input to the semi-autonomous or autonomous robot is provided from a location remote from the robot.

In some examples, a non-transitory computer readable medium is provided comprising instructions that, when executed on a processor, deliver a sensor pack to a deployment location near a first equipment to be monitored, the sensor pack including a processor, a non-transitory computer readable memory, a battery, a data port, and at least one sensor; deploy the sensor pack using a semi-autonomous or autonomous robot to the first equipment; retrieve the sensor pack from the first equipment using the semi-autonomous or autonomous robot; charge the battery of the sensor pack; download sensor data from the sensor pack; and send downloaded sensor data from the sensor pack to a processor remote from the deployment location. In certain examples, the non-transitory computer readable medium comprises instructions, that when executed on a processor, affix the sensor pack to the first equipment and affixing the at least one sensor to the first equipment. In certain examples, the non-transitory computer readable medium comprises instructions, that when executed on a processor, scan the first equipment for an identifier; retrieve from a database a predetermined location for placing a sensor on the first equipment; and affix the at least one sensor to the predetermined location on the first equipment. In certain examples, the non-transitory computer readable medium comprises instructions, that when executed on a processor, retrieve from the database a second predetermined location for placing a second sensor on the first equipment; and affix a second sensor of the sensor pack to the second predetermined location on the first equipment. In certain examples, the non-transitory computer readable medium comprises instructions, that when executed on a processor, before retrieving the sensor pack from the first equipment, deploy a second sensor pack using the semi-autonomous or autonomous robot to a second equipment. In certain examples, the non-transitory computer readable medium comprises instructions, that when executed on a processor, after retrieving the sensor pack from the first equipment, deploy the sensor pack using the semi-autonomous or autonomous robot to a second equipment.

In some examples, a method is provided comprising retrieving a sensor pack from a location proximate the first equipment using a semi-autonomous or autonomous robot; retrieving sensor data from the sensor pack; inputting the data from the sensor pack to a machine learning model; decoding a response from the machine learning model to identify a specific intervention; and deploying the semi-autonomous or autonomous robot to the first equipment to perform an intervention. In certain examples, the method comprises placing the sensor pack, which comprises an imaging system, proximate the first equipment and framing the first equipment in the field of view of the imaging system. In certain examples, the imaging system does not include a human interface. In certain examples, the method comprises attaching the sensor pack to the first equipment; and retrieving a vibration sensor from the sensor pack and attaching the vibration sensor to a predetermined location on the first equipment; wherein, retrieving the sensor pack from the location proximate the first equipment includes detaching the vibration sensor and stowing the vibration sensor in the sensor pack. In certain examples, deploying the semi-autonomous or autonomous robot to the first equipment to perform an intervention comprises: removing a failing or failed part from the first equipment; retrieving a replacement part from a cache of replacement parts; and installing the replacement part into the first equipment. In certain examples, the method comprises delivering to the location proximate the first equipment via an autonomous or semi-autonomous vehicle, the sensor pack, a cache of replacement parts, and the semi-autonomous or autonomous robot.

In some examples, a non-transitory computer readable memory is provided comprising instructions, that when executed on a processor, retrieve a sensor pack from a location proximate the first equipment using a semi-autonomous or autonomous robot; retrieve sensor data from the sensor pack; input the data from the sensor pack to a machine learning model; decode a response from the machine learning model to identify a specific intervention; and deploy the semi-autonomous or autonomous robot to the first equipment to perform an intervention. In certain examples, the non-transitory computer readable memory comprises instructions, that when executed on a processor, place the sensor pack, which comprises an imaging system, proximate the first equipment and frame the first equipment in the field of view of the imaging system. In certain examples, the non-transitory computer readable memory comprises instructions, that when executed on a processor, attach the sensor pack to the first equipment; and retrieve a vibration sensor from the sensor pack and attaching the vibration sensor to a predetermined location on the first equipment; wherein, instructions to retrieve the sensor pack from the location proximate the first equipment include instructions to detach the vibration sensor and stowing the vibration sensor in the sensor pack. In certain examples, the non-transitory computer readable memory comprises instructions, that when executed on a processor, remove a failing or failed part from the first equipment; retrieve a replacement part from a cache of replacement parts; and install the replacement part into the first equipment. In certain examples, the non-transitory computer readable memory comprises instructions, that when executed on a processor, deliver to the location proximate the first equipment via an autonomous or semi-autonomous vehicle, the sensor pack, a cache of replacement parts, and the semi-autonomous or autonomous robot.

In some examples, a system is provided comprising a semi-autonomous or autonomous vehicle comprising a sensor pack, a semi-autonomous or autonomous robot, and a cache of replacement parts; and a non-transitory computer readable memory comprising instructions that when executed on a processor, retrieve a sensor pack from a location proximate the first equipment using a semi-autonomous or autonomous robot; retrieve sensor data from the sensor pack; input the data from the sensor pack to a machine learning model; decode a response from the machine learning model to identify a specific intervention; and deploy the semi-autonomous or autonomous robot to the first equipment to perform an intervention. In certain examples, the non-transitory computer readable memory comprises instructions, that when executed on a processor, place the sensor pack, which comprises an imaging system, proximate the first equipment and frame the first equipment in the field of view of the imaging system. In certain examples, the imaging system does not include a human interface. In certain examples, the non-transitory computer readable memory comprises instructions, that when executed on a processor, attach the sensor pack to the first equipment; and retrieve a vibration sensor from the sensor pack and attaching the vibration sensor to a predetermined location on the first equipment; wherein, instructions to retrieve the sensor pack from the location proximate the first equipment include instructions to detach the vibration sensor and stowing the vibration sensor in the sensor pack. In certain examples, the non-transitory computer readable memory comprises instructions, that when executed on a processor, remove a failing or failed part from the first equipment; retrieve a replacement part from a cache of replacement parts; and install the replacement part into the first equipment. In certain examples, the non-transitory computer readable memory comprises instructions, that when executed on a processor, deliver to the location proximate the first equipment via an autonomous or semi-autonomous vehicle, the sensor pack, a cache of replacement parts, and the semi-autonomous or autonomous robot. In certain examples, the sensor pack comprises a magnetic surface for securing the sensor pack to the first equipment. In certain examples, the sensor pack comprises a tethered vibration sensor communicatively coupled to the sensor pack and the non-transitory computer readable memory comprising instructions that when executed on a processor instruct the robot to secure the vibration sensor to a predetermined location on the first equipment. In certain examples, the system comprises a database of instructions for installing replacement parts from the cache of replacement parts.

### BRIEF DESCRIPTION OF THE FIGURES

FIG. 1 illustrates a system for deploying sensor packs, according to certain examples.

FIG. 2 illustrates a deployed sensor pack, according to certain examples.

FIG. 3 illustrates method for performing robotic predictive maintenance, according to certain examples.

FIG. 4 illustrates a system for deploying maintenance, diagnostic, and repair services, according to certain examples.

FIG. 5 illustrates a method for performing robotic maintenance, diagnosis, or repair, according to certain examples.

### DETAILED DESCRIPTION

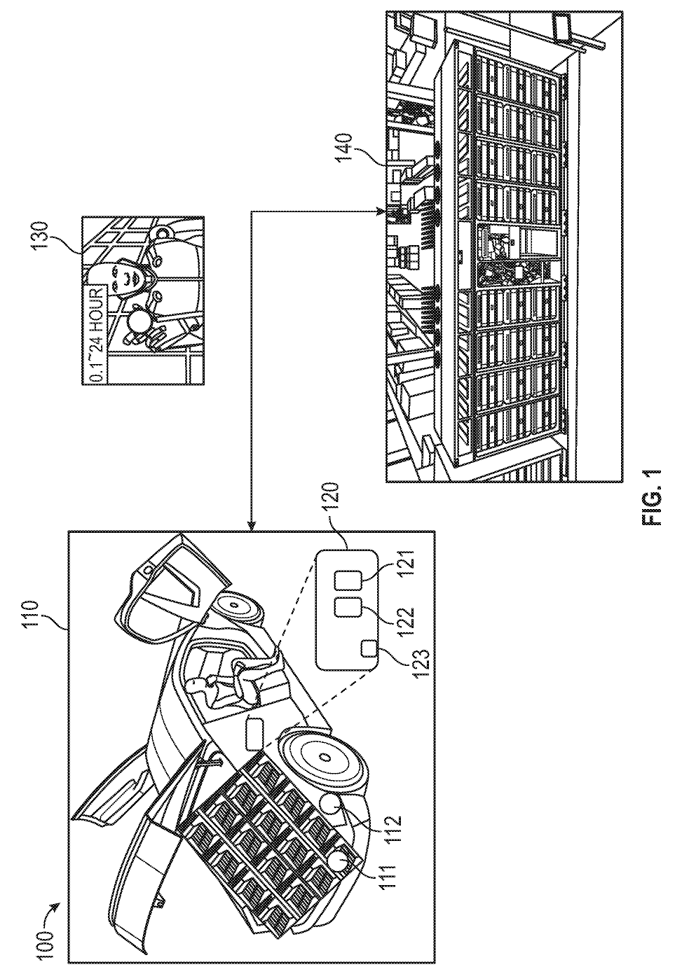

FIG. 1 illustrates a system for deploying sensor packs, according to certain examples. System 100 includes sensor deployment vehicle 110, sensor deployment robot 130, and equipment 140. Sensor deployment vehicle 110 may be an electric vehicle or other vehicle with a power supply for charging sensor packs, in certain examples. In some examples, sensor deployment vehicle 110 may be a boat or a submarine. In some examples, sensor deployment vehicle 110 may be an autonomous or remotely piloted vehicle to allow deployment and retrieval of sensors at locations remote from human operators. Sensor deployment vehicle 110 may comprise receptacles 111 for multiple sensor packs. Each receptacle 111 may include a port for transferring data from the sensor pack and for providing power to recharge a battery in the sensor pack. Sensor deployment vehicle 110 may include power supply 112, such as a large battery pack sufficient to charge multiple sensor packs simultaneously. Sensor deployment vehicle 110 may comprise data collection computer 120, which includes processor 121, non-transitory computer readable memory 122 comprising instructions for downloading data from the sensor packs and recharging those packs, and data interface 123 for downloading data from the sensor packs. Sensor deployment robot 130 may deploy and retrieve sensor packs. Sensor deployment robot 130 may be a humanoid robot in some examples, such as a TESLA OPTIMUS™ or APPTRONICK APOLLO™. In some examples, sensor deployment robot 130 may take a non-humanoid form such as the BOSTON DYNAMICS SPOT™ robot. Sensor deployment robot 130 may include an arm for affixing individual sensors to predetermined locations on equipment 140. In some examples, sensor deployment robot 130 may be a quadcopter (or other airborne drone) with an arm to aid in affixing and removing sensor pack 231 and sensors 236, 237, and 238.

Equipment 140 may be any type of electrical, mechanical, or electromechanical equipment subject to wear or component failure.

In some examples, equipment 140 may be one of dozens of industrial storage batteries in a grid-scale power backup site. Each battery may be monitored for, in some examples, a few minutes at a time or a few hours at a time. In some examples, equipment 140 may emit gases in a particular failure mode. Sensor deployment robot 130 may deploy a gas sensor in proximity to equipment 140 to sense these emissions. In another example, equipment 140 may be a subsea amplifier for a fiber optic cable. An autonomous submersible vehicle may deploy a sensor pack to each subsea amplifier in a cluster, capture data for a period of, for example, minutes or hours and the retrieve the sensor packs before proceeding to the next cluster of amplifiers. In some examples, equipment 140 may be a power transformer deployed near a remote solar or wind farm. Sensor deployment robot 130 may deploy a temperature sensor pack on the transformer and return hours or days later to retrieve the sensor pack. In some examples, sensor deployment robot 130 may deploy an oil testing apparatus to test oil for dielectric strength, water content, acidity, sludge, and flash point.

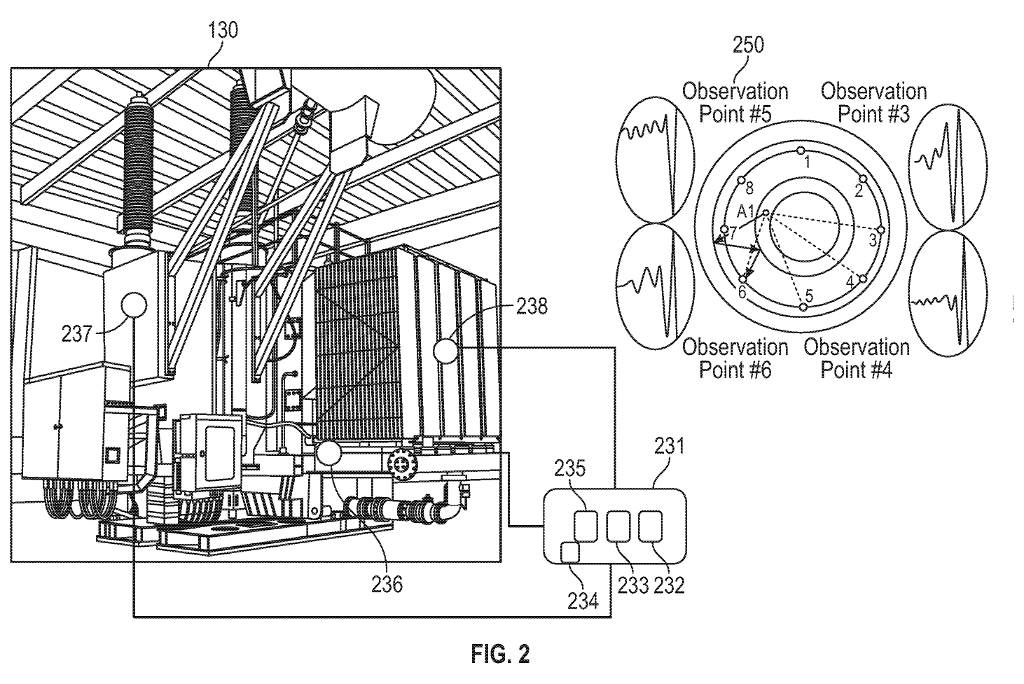

FIG. 2 illustrates a deployed sensor pack, according to certain examples. Equipment 140 is illustrated with three visible observation points. Sensor pack 231 may include a housing enclosing processor 232, non-transitory computer readable memory 233, input/output port 234 and battery 235. Sensor pack 231 may include sensors 236, 237, and 238. Sensors (e.g., sensor 236) may include a temperature probe, a vibration sensor, a gas detection sensor, a voltage or current sensor, or a camera, in certain examples. In some examples, sensor pack 231 may include multiple sensors of the same type. Observation point template 250 may illustrate the locations on equipment 140 for placing sensors 236, 237, and 238. Observation point template 250 may be associated with a particular model of equipment 130, in some examples. Observation point template may be associated with a data model for identifying abnormal conditions. In some examples, the data model may be a range of normal operating temperatures. In other examples, the data model may be a trained machine learning model that can be used to identify abnormal vibration patterns. In some examples, sensors 236, 237, and 238 may be temporarily affixed to machine 130 at locations specified in observation point template 250 during a period of observation and then removed. In some examples, a sensor may be affixed via a magnetic connection, a captive bolt or nut to thread to a point on equipment 140, clasps, toggles, clips, or other suitable mechanisms. In some examples, sensors 236, 237, and 238 may be tethered to sensor pack 231 via one or more cords. In some examples, sensors 236, 237, and 238 may be arranged serially along a cable. In some examples, sensors 236, 237, and 238 may be individually tethered to sensor pack 231. Sensor pack 231 may provide power to sensors 236, 237, and 238 and may store sensor measurement values in non-transitory computer readable memory 233. In some examples, sensor pack 231 may include a wireless data transceiver to provide sensor data to a monitoring facility.

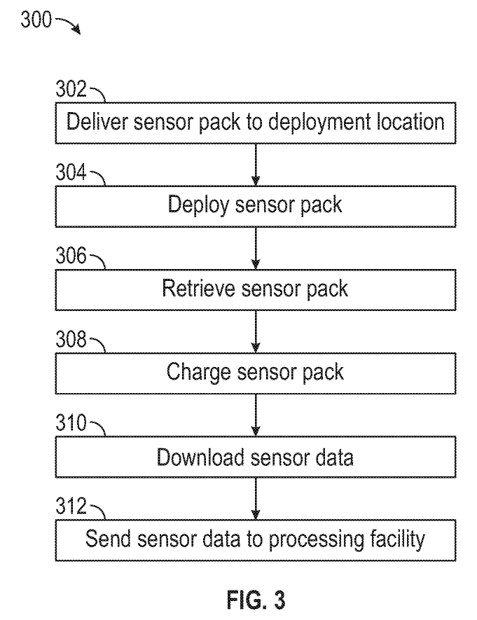

FIG. 3 illustrates method 300 for performing robotic predictive maintenance, according to certain examples. At block 302, a sensor deployment vehicle 110 may deliver sensor pack 231 to a deployment location near a machine to be observed. In some examples, the deployment location is sufficiently near the machine to be observed that sensor deployment robot 130 may deploy sensor pack 231 without need to recharge its batteries. In some examples, the deployment location may be approximately equidistant from multiple machines to be observed to allow efficient deployment of sensor pack 231 to each machine without relocating sensor deployment vehicle 110. In some examples, the deployment location may be sufficiently close to multiple machines to be observed to allow efficient deployment of sensor packs 231 to each machine. In some examples, sensor deployment vehicle 110 may deliver sensor pack 231 to a deployment location near a machine to be observed and may relocate to a location near another machine to be observed.

At block 304, sensor deployment robot 130 may deploy a sensor pack 231 from sensor deployment vehicle 110. Sensor deployment robot 130 may ride along with sensor deployment vehicle 110 in some examples. In some examples, sensor deployment vehicle 110 may relocate to a location near another machine to be observed while sensor deployment robot 130 deploys sensor pack 231. In some examples, sensor deployment robot 130 may secure sensor pack 231 to equipment 140. Sensor deployment robot 130 may secure sensor 236 to a first observation point, sensor 237 to a second observation point, and sensor 238 to a third observation point on equipment 140. At block 306, after sensor pack 231 has been deployed on equipment 140 for at least a predetermined amount of time, sensor deployment robot 130 may retrieve sensor pack 231 from equipment 140. Sensor deployment robot 130 may release each of sensors 236, 237, and 238 and release sensor pack 231. Sensor deployment robot 130 may return sensor pack 231 to sensor deployment vehicle 110. In some examples, sensor deployment robot 130 may place sensor pack 231 in a docking location within sensor deployment vehicle 110. At block 308, sensor deployment vehicle 110 may begin charging the battery of sensor pack 231. In some examples, sensor pack 231 may include a detachable battery pack and block 308 may include replacing a detachable battery with a previously charged detachable battery pack. At block 310, sensor deployment vehicle 110 may download sensor data from sensor pack 231 to non-transitory computer readable memory 233. In some examples at block 312, sensor deployment vehicle 110 may transmit sensor data to a central facility for processing. In some examples, method 300 returns to block 302.

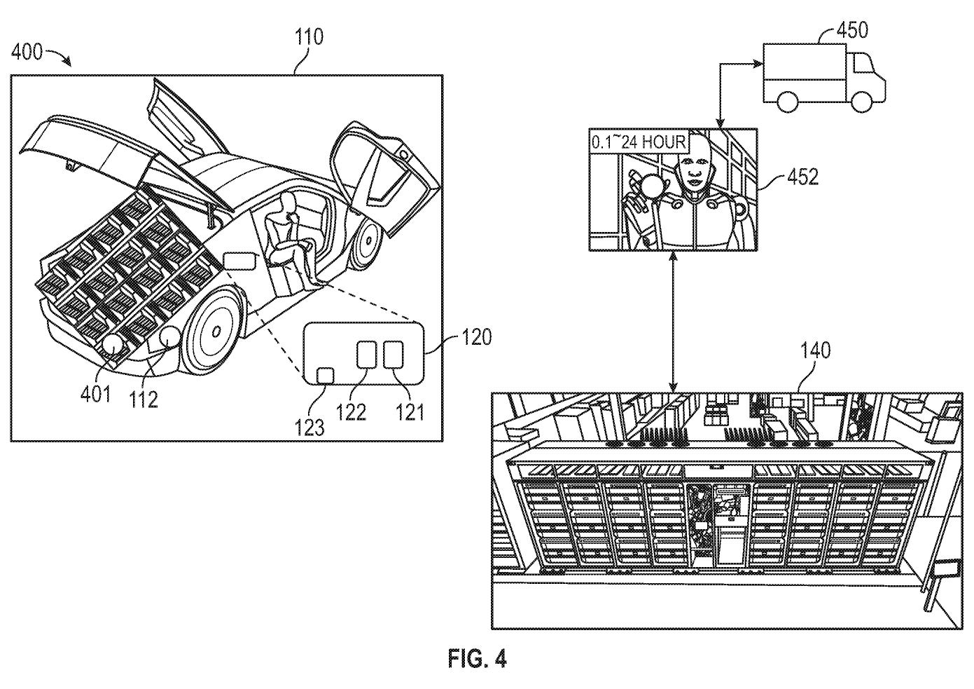

FIG. 4 illustrates a system for deploying maintenance, diagnostic, and repair services, according to certain examples. System 400 includes sensor deployment vehicle 110, maintenance supply vehicle 450, maintenance robot 452, and equipment 140. Sensor deployment vehicle 110 may be an electric vehicle or other vehicle with a power supply for charging sensor packs, in certain examples. In some examples, sensor deployment vehicle 110 may be a boat or a submarine. Maintenance supply vehicle 450 may be, for example, a self-driving truck housing a cache of replacement components, supplies, and/or tools for maintaining, repairing, and/or replacing parts of equipment 140. Maintenance robot 452 may be a humanoid robot, for example, tasked with repairing, maintaining, and/or replacing components of equipment 150. For example, maintenance robot 452 may be deployed to refill oil in a remotely located power transformer. In other example, maintenance robot 452 may be deployed to replace a battery module of a grid scale battery. In some examples, sensor deployment vehicle 110 may also perform the function of maintenance supply vehicle 450. In some examples, sensor deployment robot 130 may also perform the function of maintenance robot 452.

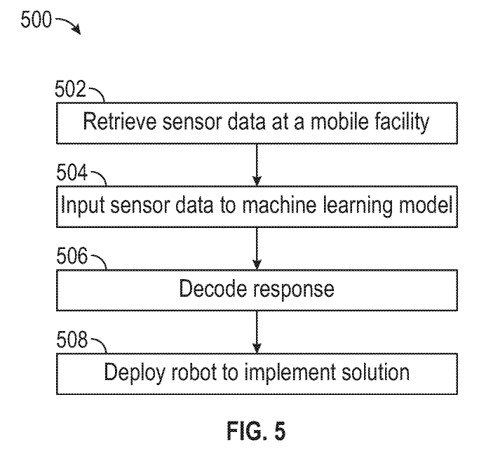

FIG. 5 illustrates a method for performing robotic maintenance, diagnosis, or repair, according to certain examples. At block 502, a sensor deployment vehicle 110 may retrieve data from sensor pack 231 representing observations of equipment 140. Sensor pack 231 may contain computer readable data without the need for expensive LCD screens or other human interfaces. For example, an optical sensor from a camera by KONICAMINOLTA™ (e.g., the sensors in the GMP02) or FLIR-TELEDYNE™ may capture data without the accompanying human interface. An optical sensor may be used to detect the release of volatile organic gases that may indicate battery degradation or failure. Operation of the camera without an LCD or other human interface saves capital cost and power.

At block 504, sensor deployment vehicle 110 may input the data from sensor pack 231 into a machine learning model trained on data relevant to equipment 140. For example, at a training time, training data may be fed into a machine learning model in the form of spectral representations of known normal equipment vibrations along with an indicator that the spectra represent normal operation. The machine learning model may be a neural network. For example, software may capture vibrations from a machine subject to a known failure mode, translate the vibrations into a spectral representation, and feed that spectral representation into a machine learning model along with an indicator that the spectral representation is abnormal. In some examples, spectral representations may be included in training data along with an indicator that each is normal. In some examples, the spectral representation may be in the form of an image that may be fed into a convolutional neural network (CNN). In some examples, the spectral representation may be an array of data that may be fed into a recurrent neural network (RNN) or a long short-term memory (LSTM) neural network. The selection of a neural network algorithm may depend on the types of anomalies (which signal a need for maintenance or repair) anticipated in a particular environment. In some examples, a spectral representation at a single point in time may capture anomalies relevant to a particular type of equipment. In some examples, a spectral representation over time may capture the anomaly or may be necessary to characterize the anomaly. In some examples, training data may be provided in the form of a library of known normal spectral representations for types of equipment in a particular environment. For example, a training library may include representations for cooling pumps and fans on a remote grid-scale battery module. In another example, a training library for wind generation facility might include representations for transmissions, bearings, and other mechanical components of a wind turbine. In some examples, a training library may include data representing known abnormal sounds (vibrations) designated as abnormal. For example, abnormal sounds may include: a crunched ball bearing in a rotating machine or the sound of a snapped transmission belt. In other examples, training data may include a spectral representation of a heat map of a piece of equipment and an indication of normal or abnormal heat distribution or levels. More specifically, a grid scale battery may include an internal liquid cooling system to even out temperatures and cool battery packs. Hotspots in an IR spectral representation may indicate a failure of the cooling system.

At block 506, sensor deployment vehicle 110 may decode a response from the machine learning model and may determine that at least some portion of equipment 140 requires intervention. For example, the machine learning model may identify a vibration signifying a failed ball bearing in a cooling fan. In another example, the machine learning model may report a failed cooling system. At block 508, sensor deployment vehicle 110 may dispatch maintenance robot 452 to retrieve needed components, supplies, and/or tools from maintenance supply vehicle 450 and to perform the required intervention. In an example, a failed ball bearing in a cooling fan may signal the need for a replacement fan module. Maintenance robot 452 may retrieve a replacement fan module, deliver that module to a battery module, and perform a replacement. In another example, a failed cooling system may trigger dispatch of maintenance robot 453 to attempt to replace a coolant pump and refill a coolant reservoir on the equipment.

Although examples have been described above, other variations and examples may be made from this disclosure without departing from the spirit and scope of these examples.

We claim:

1. A method comprising:
communicating with a semi-autonomous or autonomous robot to coordinate retrieval of a sensor pack from a location proximate the first equipment;
retrieving sensor data from the sensor pack;
inputting the data from the sensor pack to a machine learning model;
decoding a response from the machine learning model to identify a specific intervention; and
dispatching the semi-autonomous or autonomous robot to the first equipment to perform an intervention.

2. The method of claim 1, comprising:
instructing the semi-autonomous or autonomous robot to place the sensor pack, which comprises an imaging system, proximate the first equipment and framing the first equipment in the field of view of the imaging system.

3. The method of claim 2, wherein the imaging system does not include a human interface.

4. The method of claim 1, comprising: instructing the semi-autonomous or autonomous robot to:
attach the sensor pack to the first equipment; and
retrieve a vibration sensor from the sensor pack and attach the vibration sensor to a predetermined location on the first equipment.

5. The method of claim 1, wherein dispatching the semi-autonomous or autonomous robot to the first equipment to perform an intervention comprises instructing the semi-autonomous or autonomous robot to:
remove a failing or failed part from the first equipment;
retrieve a replacement part from a cache of replacement parts; and
install the replacement part into the first equipment.

6. The method of claim 1, comprising:
delivering to the location proximate the first equipment via an autonomous or semi-autonomous vehicle, the sensor pack, a cache of replacement parts, and the semi-autonomous or autonomous robot.

7. A non-transitory computer readable memory comprising instructions, that when executed on a processor:
communicate with a semi-autonomous or autonomous robot to coordinate retrieval of a sensor pack from a location proximate the first equipment;
retrieve sensor data from the sensor pack;
input the data from the sensor pack to a machine learning model;
decode a response from the machine learning model to identify a specific intervention; and
dispatch the semi-autonomous or autonomous robot to the first equipment to perform an intervention.

8. The non-transitory computer readable memory of claim 7 comprising instructions, that when executed on a processor, instruct the semi-autonomous or autonomous robot to:
place the sensor pack, which comprises an imaging system, proximate the first equipment and frame the first equipment in the field of view of the imaging system.

9. The non-transitory computer readable memory of claim 7 comprising instructions, that when executed on a processor, instruct the semi-autonomous or autonomous robot to:
attach the sensor pack to the first equipment; and
retrieve a vibration sensor from the sensor pack and attach the vibration sensor to a predetermined location on the first equipment.

10. The non-transitory computer readable memory of claim 7 comprising instructions, that when executed on a processor, instruct the semi-autonomous or autonomous robot to:
remove a failing or failed part from the first equipment;
retrieve a replacement part from a cache of replacement parts; and
install the replacement part into the first equipment.

11. The non-transitory computer readable memory of claim 7 comprising instructions, that when executed on a processor:
deliver to the location proximate the first equipment via an autonomous or semi-autonomous vehicle, the sensor pack, a cache of replacement parts, and the semi-autonomous or autonomous robot.

12. A system, comprising:
a semi-autonomous or autonomous vehicle comprising:
a sensor pack,
a semi-autonomous or autonomous robot, and
a cache of replacement parts; and
a non-transitory computer readable memory comprising instructions that when executed on a processor:
communicate with the semi-autonomous or autonomous robot to coordinate retrieval of a sensor pack from a location proximate the first equipment using a semi-autonomous or autonomous robot;
retrieve sensor data from the sensor pack;
input the data from the sensor pack to a machine learning model;
decode a response from the machine learning model to identify a specific intervention; and
dispatch the semi-autonomous or autonomous robot to the first equipment to perform an intervention.

13. The system of claim 12, the non-transitory computer readable memory comprising instructions that when executed on the processor, instruct the semi-autonomous or autonomous robot to:
place the sensor pack, which comprises an imaging system, proximate the first equipment and frame the first equipment in the field of view of the imaging system.

14. The system of claim 13, wherein the imaging system does not include a human interface.

15. The system of claim 12, the non-transitory computer readable memory comprising instructions that when executed on a processor, instruct the semi-autonomous or autonomous robot to:
attach the sensor pack to the first equipment; and
retrieve a vibration sensor from the sensor pack and attaching the vibration sensor to a predetermined location on the first equipment;
wherein, instructions to retrieve the sensor pack from the location proximate the first equipment include instructions to detach the vibration sensor and stowing the vibration sensor in the sensor pack.

16. The system of claim 12, the non-transitory computer readable memory comprising instructions that when executed on a processor, instruct the semi-autonomous or autonomous robot to:
remove a failing or failed part from the first equipment;
retrieve a replacement part from a cache of replacement parts; and
install the replacement part into the first equipment.

17. The system of claim 12, the non-transitory computer readable memory comprising instructions that when executed on a processor:
deliver to the location proximate the first equipment via an autonomous or semi-autonomous vehicle, the sensor pack, a cache of replacement parts, and the semi-autonomous or autonomous robot.

18. The system of claim 12, wherein the sensor pack comprises a magnetic surface for securing the sensor pack to the first equipment.

19. The system of claim 12, wherein the sensor pack comprises a tethered vibration sensor communicatively coupled to the sensor pack and the non-transitory computer readable memory comprising instructions that when executed on a processor instruct the robot to secure the vibration sensor to a predetermined location on the first equipment.

20. The system of claim 12, comprising a database of instructions for installing replacement parts from the cache of replacement parts.
